(19) United States
(12) Patent Application Publication
(10) Pub. No.: US 2022/0073052 A1
(43) Pub. Date: Mar. 10, 2022

(54) ARTIFICIAL INTELLIGENCE AMPHIBIOUS VERTICAL TAKE-OFF AND LANDING MODULAR HYBRID FLYING AUTOMOBILE

(71) Applicants: Dylan T X Zhou, Belvedere Tiburon, CA (US); Andrew H B Zhou, Tiburon, CA (US); Tiger T G Zhou, Tiburon, CA (US)

(72) Inventors: Dylan T X Zhou, Belvedere Tiburon, CA (US); Andrew H B Zhou, Tiburon, CA (US); Tiger T G Zhou, Tiburon, CA (US)

(21) Appl. No.: 17/245,164

(22) Filed: Apr. 30, 2021

Related U.S. Application Data
(63) Continuation-in-part of application No. 29/776,693, filed on Mar. 31, 2021.
Application No. 29/776,693 is a continuation-in-part of application No. 29/684,687, filed on Mar. 22, 2019.
Application No. 29/684,687 is a continuation-in-part of application No. 15/484,177, filed on Apr. 11, 2017, now abandoned.
Application No. 15/484,177 is a continuation-in-part of application No. 15/061,982, filed on Mar. 4, 2016, now Pat. No. 9,619,794.
Application No. 15/061,982 is a continuation-in-part of application No. 14/815,988, filed on Aug. 1, 2015, now Pat. No. 9,342,829.
Application No. 14/815,988 is a continuation-in-part of application No. 14/034,509, filed on Sep. 23, 2013, now Pat. No. 9,510,277.
Application No. 14/034,509 is a continuation-in-part of application No. 10/677,098, filed on Sep. 30, 2003, now Pat. No. 7,702,739.
(60) Provisional application No. 60/415,546, filed on Oct. 1, 2002.

(51) Int. Cl. B60W 20/20; B64C 39/02; B60W 30/18

(52) U.S. Cl. CPC B60W 20/20; B64C 39/024; B60W 30/18109; B64C 2201/128; B60W 2420/52; B64C 2201/208; B60W 2554/4029; B60W 2420/42; B64C 2201/066; B64C 2201/205; B64C 2201/206; B60W 2554/4049

(57) ABSTRACT

Provided is an artificial intelligence (AI) amphibious vertical take-off and landing modular hybrid flying automobile. The automobile may include a vehicle and a drone. The vehicle may include a vehicle body, a chassis, an engine, a transmission unit, a steering unit, a brake unit, an AI vehicle control unit, and one or more batteries. The vehicle may further include a wind turbine, a fuel cell stack, a hydrogen storage tank, an AI control unit, a plurality of sensors, and an obstacle detection module in communication with the plurality of sensors. The obstacle detection module may be configured to detect an obstacle and activate the brake unit. The drone may include a connection unit configured to releasably attach to a top of the vehicle body of the vehicle, a drone body, propellers configured to provide a vertical take-off and landing, and an AI drone control unit.

### CROSS-REFERENCE TO RELATED APPLICATIONS

This application claims the benefit and priority date of and is a continuation-in-part of U.S. patent application Ser. No. 29/776,693, entitled “ARTIFICIAL INTELLIGENCE ALGORITHM STEPS AMPHIBIOUS VERTICAL TAKE-OFF AND LANDING MODULAR HYBRID FLYING AUTOMOBILE TIGON (AI MOBILE TIGON),” filed on Mar. 31, 2021, which in turn is a continuation-in-part of U.S. patent application Ser. No. 29/684,687 filed on Mar. 22, 2019, which is a continuation-in-part of U.S. patent application Ser. No. 15/484,177, entitled “SYSTEMS AND METHODS FOR PROVIDING COMPENSATION, REBATE, CASHBACK, AND REWARD FOR USING MOBILE AND WEARABLE PAYMENT SERVICES, DIGITAL CURRENCY, NFC TOUCH PAYMENTS, MOBILE DIGITAL CARD BARCODE PAYMENTS, AND MULTIMEDIA HAPTIC CAPTURE BUYING,” filed on Apr. 11, 2014, which is a continuation in part of U.S. patent application Ser. No. 15/061,982, entitled “SYSTEMS AND METHODS FOR PROVIDING COMPENSATION, REBATE, CASHBACK, AND REWARD FOR USING MOBILE AND WEARABLE PAYMENT SERVICES, DIGITAL CURRENCY, NFC TOUCH PAYMENTS, MOBILE DIGITAL CARD BARCODE PAYMENTS, AND MULTIMEDIA HAPTIC CAPTURE BUYING” filed on Mar. 4, 2016, which claims priority to U.S. patent application Ser. No. 14/815,988, entitled “SYSTEMS AND METHODS FOR MOBILE APPLICATION, WEARABLE APPLICATION, TRANSACTIONAL MESSAGING, CALLING, DIGITAL MULTIMEDIA CAPTURE AND PAYMENT TRANSACTIONS”, filed on Aug. 1, 2015, which claims priority to U.S. patent application Ser. No. 14/034,509, entitled “EFFICIENT TRANSACTIONAL MESSAGING BETWEEN LOOSELY COUPLED CLIENT AND SERVER OVER MULTIPLE INTERMITTENT NETWORKS WITH POLICY BASED ROUTING”, filed on Sep. 23, 2013, and which claims priority to U.S. patent application Ser. No. 10/677,098, entitled “EFFICIENT TRANSACTIONAL MESSAGING BETWEEN LOOSELY COUPLED CLIENT AND SERVER OVER MULTIPLE INTERMITTENT NETWORKS WITH POLICY BASED ROUTING”, filed on Sep. 30, 2003, which claims priority to U.S. Provisional Patent Application No. 60/415,546, entitled “DATA PROCESSING SYSTEM”, filed on Oct. 1, 2002, and this application is a continuation-in-part of U.S. patent application Ser. No. 29/578,694, entitled “AMPHIBIOUS UNMANNED VERTICAL TAKEOFF AND LANDING AIRCRAFT” filed on Sep. 23, 2016, which is continuation-in-part of U.S. patent application Ser. No. 29/572,722, filed on Jul. 29, 2016, and a continuation of U.S. patent application Ser. No. 29/567,712, filed on Jun. 10, 2016, and a continuation-in-part of U.S. patent application Ser. No. 14/940,379, filed on Nov. 13, 2015, now U.S. Pat. No. 9,493,235, which is a continuation-in-part of U.S. patent application Ser. No. 14/034,509, filed on Sep. 23, 2013, now U.S. Pat. No. 9,510,277, which are incorporated herein by reference in their entirety.

### FIELD

This application relates generally to hybrid automobiles and, more specifically, to artificial intelligence amphibious vertical take-off and landing modular hybrid flying automobiles.

### BACKGROUND

Development of hybrid automobiles having multiple power sources is one of branches of automobile industry. The power sources conventionally include an internal combustion engine and an electric engine. Some countries developed strategies to refuse from using internal combustion engines in automobiles and broaden the use of electric cars. The most spread electric cars have only one power source in form of an electric engine. However, electric cars that combine multiple power sources such as hydrogen fuel cells, wind turbines, and solar batteries are still not widely spread. Moreover, most of cars are implied to drive over roads, but are usually inapplicable for travelling by air or under water.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is an artificial intelligence (AI) amphibious vertical take-off and landing modular hybrid flying automobile. The automobile may include a vehicle and a drone. The vehicle may include a vehicle body, a chassis carrying the vehicle body, an engine located in the vehicle body, a transmission unit in communication with the engine, a steering unit in communication with the transmission unit, a brake unit in communication with the chassis, an AI vehicle control unit, and one or more batteries including one or more of a metal battery, a solid state metal battery, and a solar battery. The brake unit may include an emergency brake unit. The vehicle may further include a wind turbine, a fuel cell stack including a hydrogen fuel cell unit, a hydrogen storage tank, and an AI control unit for controlling the at least one of the engine, the one or more batteries, the wind turbine, and the fuel cell stack. The vehicle may further include a plurality of sensors and an obstacle detection module in communication with the plurality of sensors. The obstacle detection module may be configured to detect an obstacle and activate the emergency brake unit. The drone may include a connection unit configured to releasably attach to a top of the vehicle body of the vehicle. The drone may further include a drone body, one or more propellers attached to the drone body and configured to provide a vertical take-off and landing of the drone, and an AI drone control unit.

In some embodiments, the vehicle may further include a projector configured to project virtual zebra lines, right turning virtual arrows, and left turning virtual arrows to a roadway in proximity to a pedestrian upon detection of the pedestrian by the obstacle detection module.

In an example embodiment, an artificial intelligence amphibious vertical take-off and landing modular hybrid flying automobile is provided. The automobile may include one or more solar panels, one or more wind turbines, one or more hydrogen tanks, and a stand-alone self-charging self-powered on-board clean energy unit for controlling the one or more solar panels, the one or more wind turbines, and one or more hydrogen tanks. The automobile may produce no pollution emissions when operating.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF DRAWINGS

Embodiments are illustrated by way of example and not limitation in the figures of the accompanying drawings, in which like references indicate similar elements and in which:

FIG. 1 is a general perspective view of a drone, according to an example embodiment.

FIG. 2 is a general perspective view of an AI amphibious vertical take-off and landing modular hybrid flying automobile that includes a drone and a vehicle, according to an example embodiment.

FIG. 3 is a right side view of an AI amphibious vertical take-off and landing modular hybrid flying automobile that includes a drone and a vehicle, according to an example embodiment.

FIG. 4 is a left side view of an AI amphibious vertical take-off and landing modular hybrid flying automobile that includes a drone and a vehicle, according to an example embodiment.

FIG. 5 is a front view of an AI amphibious vertical take-off and landing modular hybrid flying automobile that includes a drone and a vehicle, according to an example embodiment.

FIG. 6 is a rear view of an AI amphibious vertical take-off and landing modular hybrid flying automobile that includes a drone and a vehicle, according to an example embodiment.

FIG. 7 is a top view of an AI amphibious vertical take-off and landing modular hybrid flying automobile that includes a drone and a vehicle, according to an example embodiment.

FIG. 8 is a bottom view of an AI amphibious vertical take-off and landing modular hybrid flying automobile that includes a drone and a vehicle, according to an example embodiment.

FIG. 9 is a general perspective view of a drone and a vehicle in a disengaged position, according to an example embodiment.

FIG. 10 is a general perspective view of a vehicle of an AI amphibious vertical take-off and landing modular hybrid flying automobile, according to an example embodiment.

FIG. 11 a front perspective view of a vehicle with doors and AI automatic falcon doors open, according to an example embodiment.

FIG. 12 shows a right side view of a vehicle with doors and AI automatic falcon doors open and projected two virtual red carpets, according to an example embodiment.

FIG. 13 shows a left side view of a vehicle with doors and AI automatic falcon doors open and projected two virtual red carpets, according to an example embodiment.

FIG. 14 shows a rear view of a vehicle with doors and AI automatic falcon doors open, according to an example embodiment.

FIG. 15 shows a front view of a vehicle with doors and AI automatic falcon doors open, according to an example embodiment.

FIG. 16 shows a top view of a vehicle with doors and AI automatic falcon doors open, according to an example embodiment.

FIG. 17 shows a bottom view of a vehicle with doors and AI automatic falcon doors open, according to an example embodiment.

FIG. 18 a general perspective view of a vehicle in a waterproof amphibious alternate configuration submerged under water, according to an example embodiment.

FIG. 19 shows an operation of an obstacle detection module of a vehicle and projecting walking virtual zebra lines and right turning and left turning virtual arrows with automatic AI interaction with pedestrians, according to an example embodiment.

FIG. 20 is a schematic diagram showing a vehicle powered by hydrogen, solar, and wind turbine energy power sources, according to an example embodiment.

FIG. 21 shows a front perspective view of an artificial intelligence amphibious vertical take-off and landing modular hybrid flying automobile, according to an example embodiment.

FIG. 22 is a left side view of an artificial intelligence amphibious vertical take-off and landing modular hybrid flying automobile, according to an example embodiment.

FIG. 23 is a right side view of an artificial intelligence amphibious vertical take-off and landing modular hybrid flying automobile, according to an example embodiment.

FIG. 24 is a front view of an artificial intelligence amphibious vertical take-off and landing modular hybrid flying automobile, according to an example embodiment.

FIG. 25 is a rear view of an artificial intelligence amphibious vertical take-off and landing modular hybrid flying automobile, according to an example embodiment.

FIG. 26 is a top view of an artificial intelligence amphibious vertical take-off and landing modular hybrid flying automobile, according to an example embodiment.

FIG. 27 is a bottom view of an artificial intelligence amphibious vertical take-off and landing modular hybrid flying automobile, according to an example embodiment.

FIG. 28 shows a front perspective view of an artificial intelligence amphibious vertical take-off and landing modular hybrid flying automobile with AI automatic falcon doors open, according to an example embodiment.

FIG. 29 is a diagrammatic representation of a computing device for a machine in the exemplary electronic form of a computer system, within which a set of instructions for causing the machine to perform any one or more of the methodologies discussed herein can be executed.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

The present disclosure relates to an artificial intelligence (AI) amphibious vertical take-off and landing modular hybrid flying automobile, also referred to as an AI algorithm steps amphibious vertical take-off and landing modular hybrid flying automobile tigon, or an AI mobile tigon, or an automobile. The automobile may be AI-controlled. Specifically, operation of all systems and parts of the automobile may be controlled by using machine learning and AI. The AI mobile tigon may be a combination of a vehicle (e.g., a car) and a drone connectable to the vehicle.

In recent time, many countries have set targets to fight against global warming. Electric vehicles (EV), also referred to as electric cars, can help prevent global warming by giving no contribution to the carbon emissions because EVs produce fewer emissions as compared to conventional vehicles. The present disclosure relates to an approach for combining solar panels, wind turbines, and hydrogen tanks in a stand-alone self-charging and self-powered on-board clean energy system to provide a vehicle producing no pollution emissions.

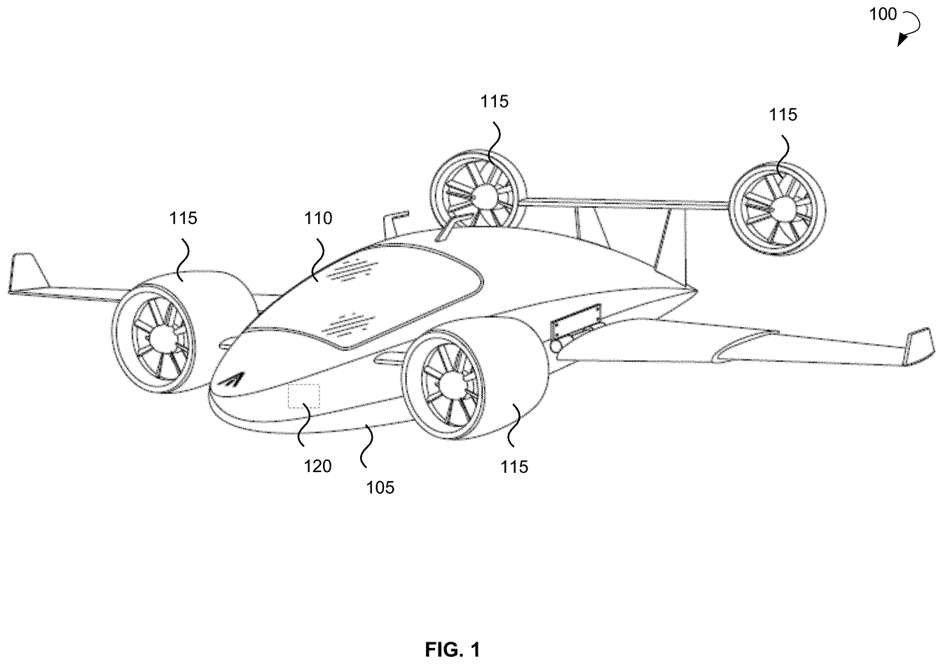

Referring now to the drawings, FIG. 1 is a general perspective view 100 of a drone 105. The drone 105 may have a drone body 110, one or more propellers 115 attached to the drone body 110, and an AI drone control unit 120. The one or more propellers 115 may be configured to provide a vertical take-off and landing of the drone 105 and provide flying of the drone 105.

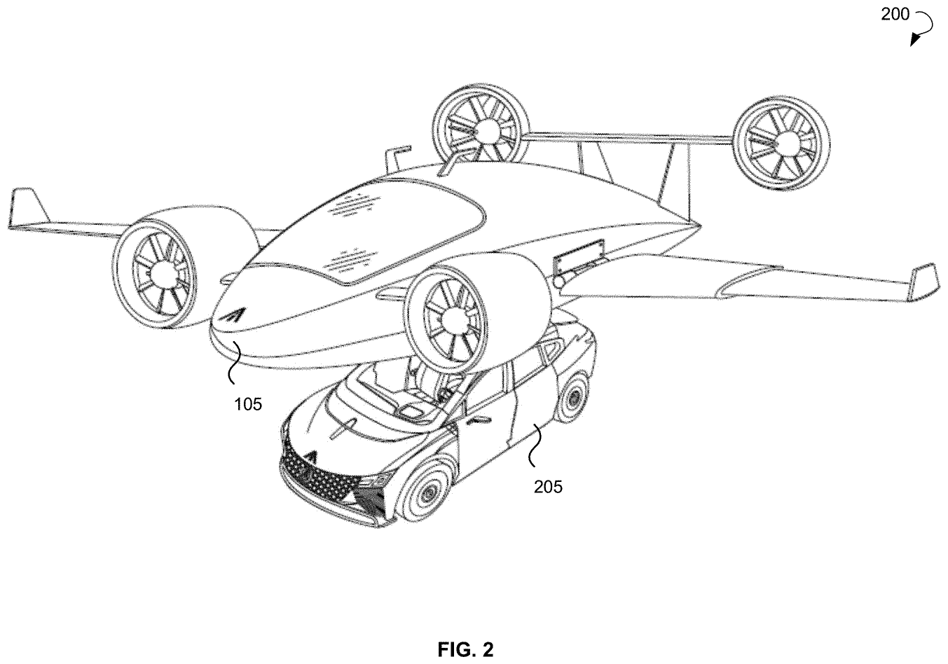

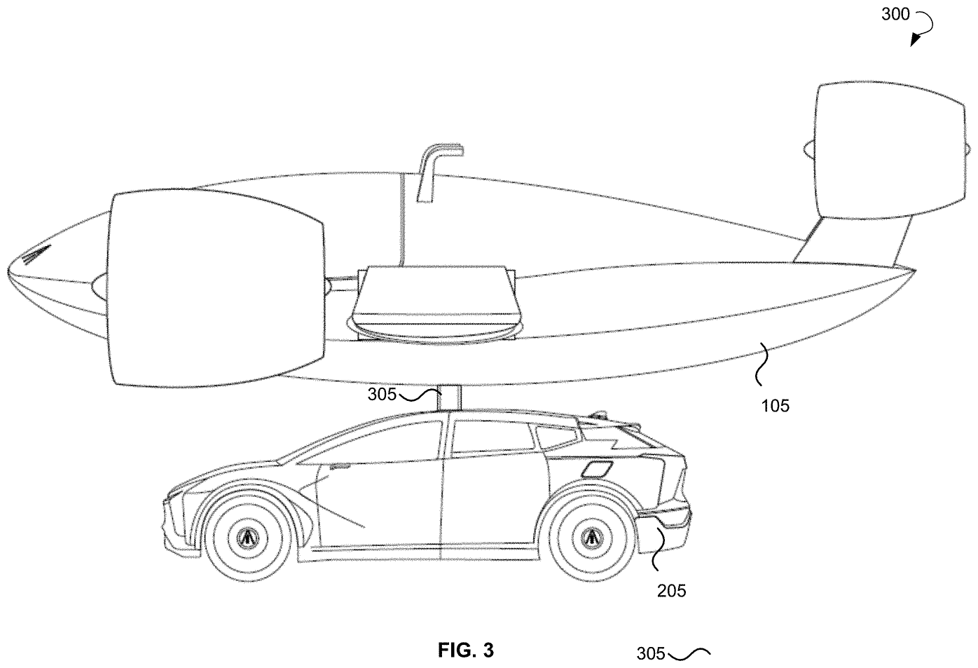

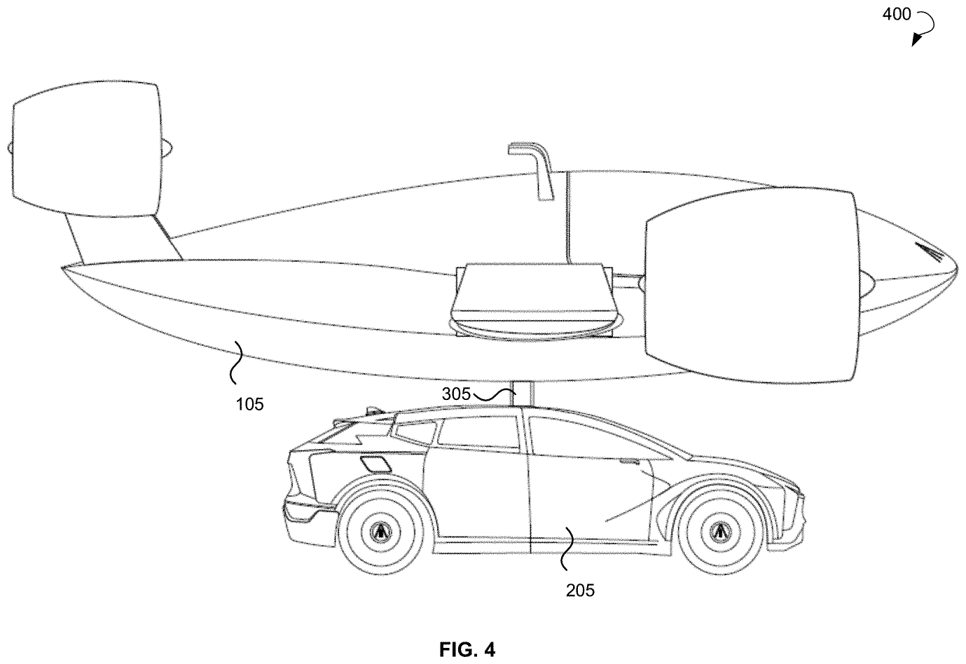

FIG. 2 is a general perspective view 200 of an AI amphibious vertical take-off and landing modular hybrid flying automobile that includes a drone 105 and a vehicle 205. FIG. 3 is a right side view 300 of the AI amphibious vertical take-off and landing modular hybrid flying automobile that includes the drone 105 and the vehicle 205. The drone 105 may include a connection unit 305 configured to releasably attach to the vehicle 205. FIG. 4 is a left side view 400 of the AI amphibious vertical take-off and landing modular hybrid flying automobile that includes the drone 105 and the vehicle 205.

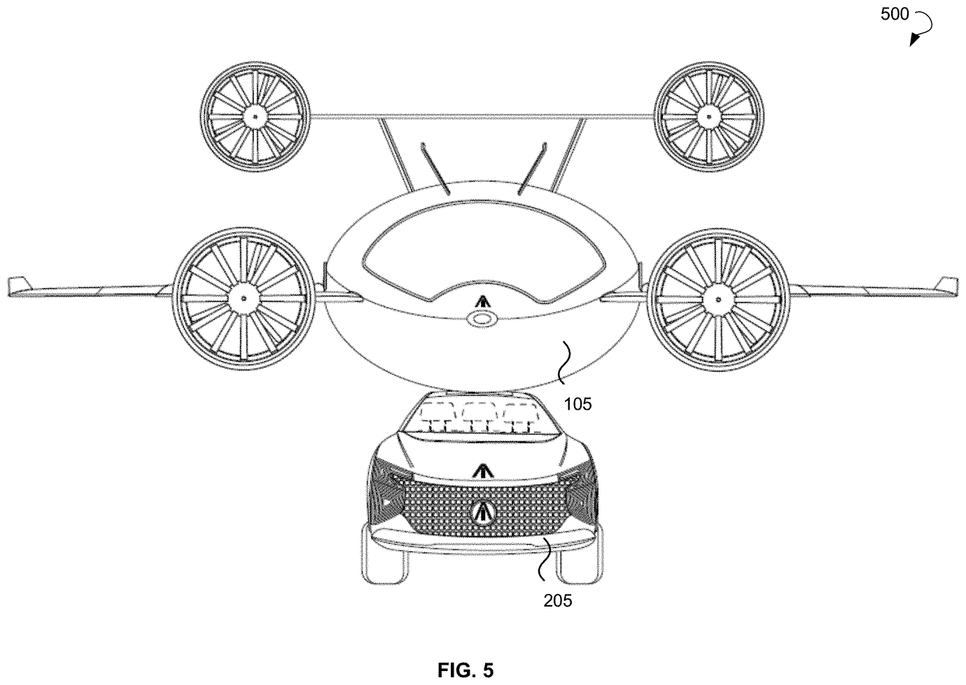

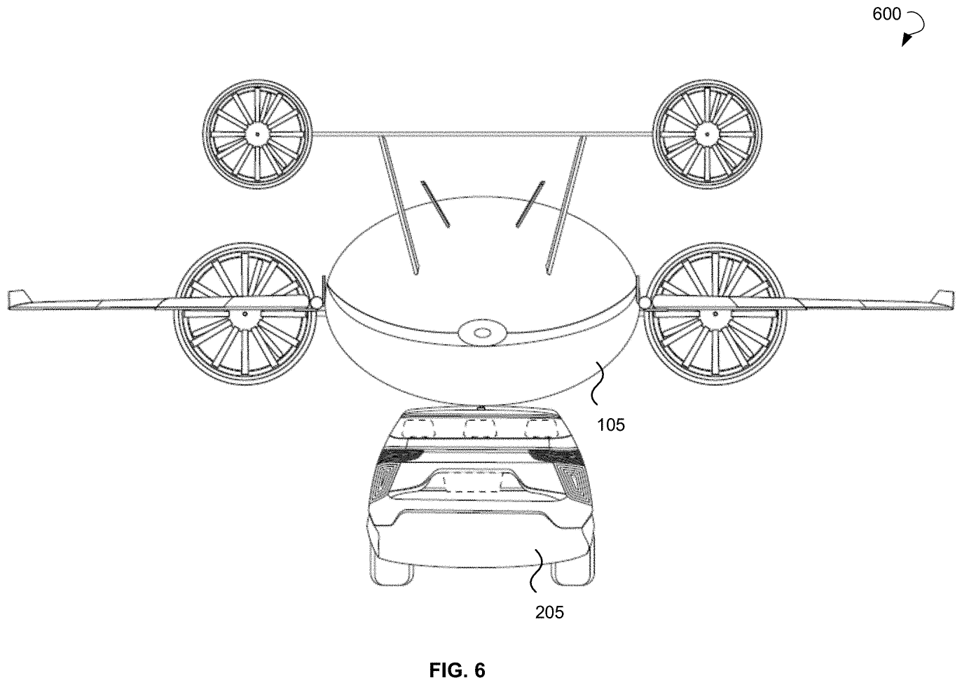

FIG. 5 is a front view 500 of the AI amphibious vertical take-off and landing modular hybrid flying automobile that includes the drone 105 and the vehicle 205. FIG. 6 is a rear view 600 of the AI amphibious vertical take-off and landing modular hybrid flying automobile that includes the drone 105 and the vehicle 205.

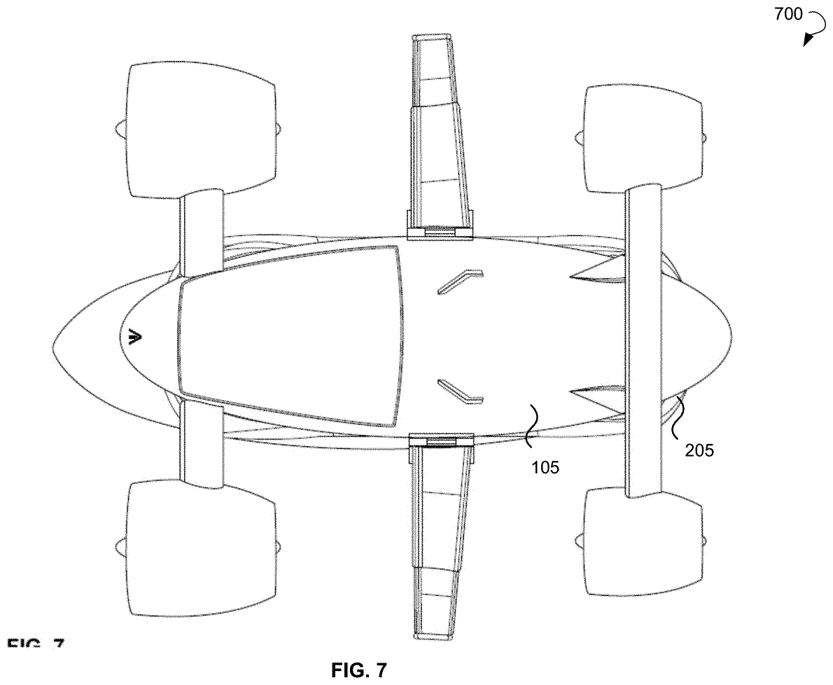

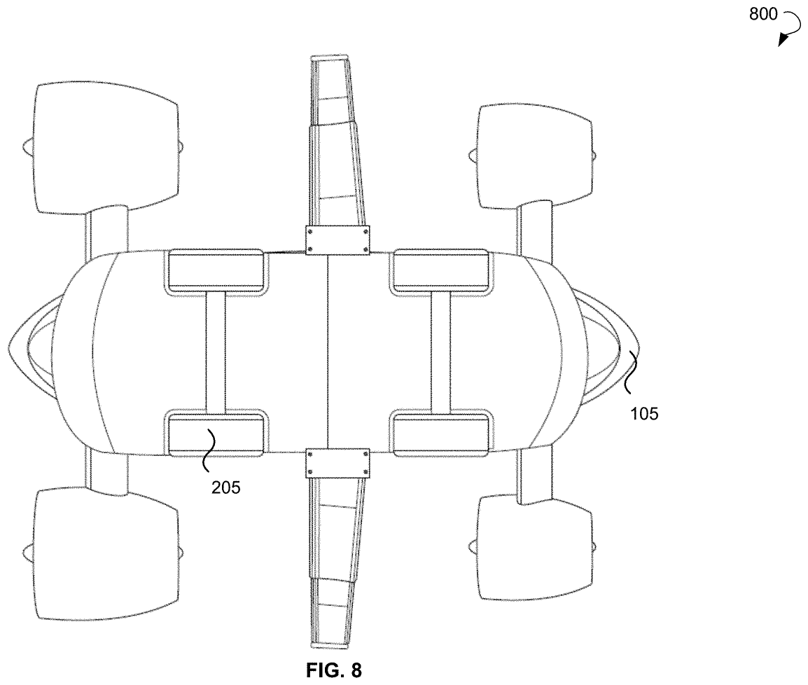

FIG. 7 is a top view 700 of the AI amphibious vertical take-off and landing modular hybrid flying automobile that includes the drone 105 and the vehicle 205. FIG. 8 is a bottom view 800 of the AI amphibious vertical take-off and landing modular hybrid flying automobile that includes the drone 105 and the vehicle 205.

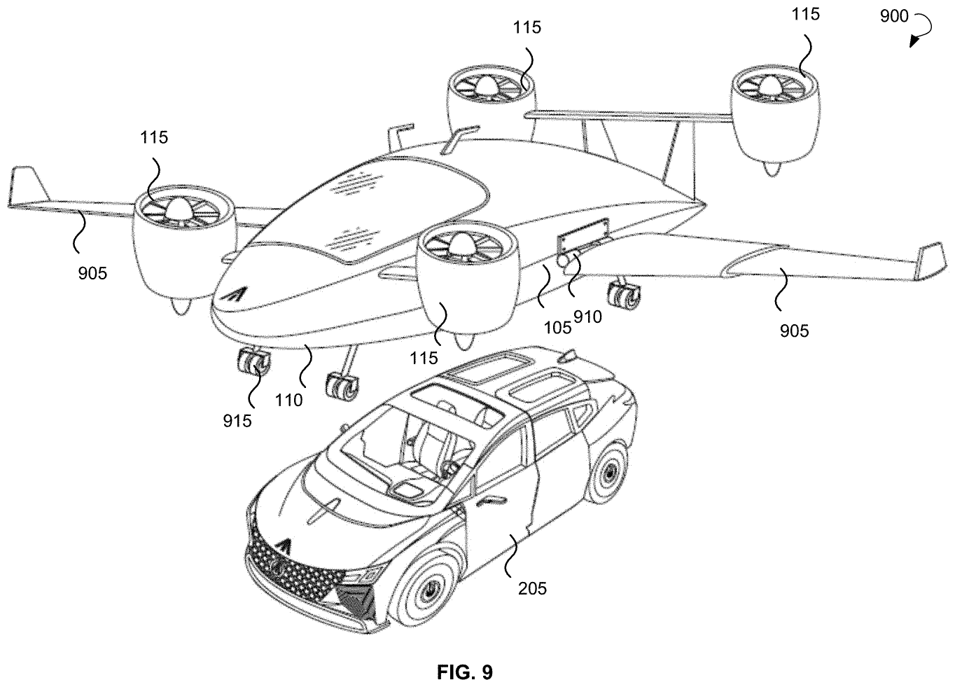

FIG. 9 is a view 900 of the drone 105 and the vehicle 205 in a disengaged position. The propellers 115 may be rotated from a horizontal position shown in FIGS. 1-8 to a vertical position shown in FIG. 9. The horizontal position of propellers 115 may be used for horizontal movement of the drone 105 with or without the vehicle 205 connected to the drone 105. The vertical position of propellers 115 shown in FIG. 9 may be used for vertical take-off and landing of the drone 105 with or without the vehicle 205 connected to the drone 105.

The drone 105 may have one or more wings 905 connected to the drone body 110 via wing connectors 910. The wings 905 may be foldable. The drone 105 may further have a chassis 915. When being disengaged from the vehicle 205, the drone 105 may use the chassis 915 for landing on a surface, such as land.

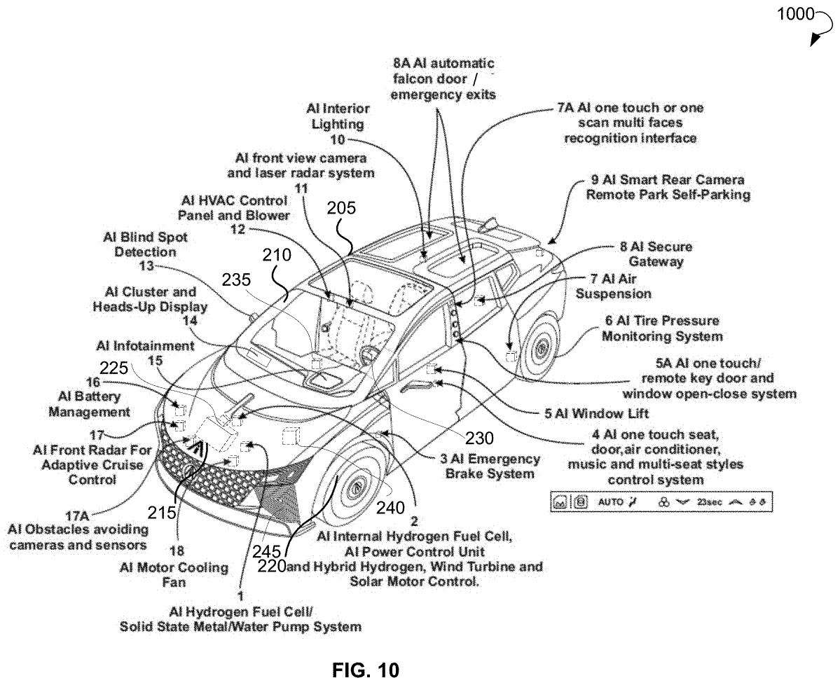

FIG. 10 is a general perspective view 1000 of a vehicle 205 of the AI amphibious vertical take-off and landing modular hybrid flying automobile. The vehicle 205 is also referred to as a seven seaters super sport utility vehicle (SUV) tigon automobile.

The vehicle 205 may include a vehicle body 210. The drone 105 shown in FIG. 1 may be configured to attach to a top of the vehicle body 210 of the vehicle 205. The vehicle 205 may further have an engine 215 located in the vehicle body 210. In an example embodiment, the engine 215 may include an electric engine. The vehicle 205 may further have a chassis 220 carrying the vehicle body 210 and a transmission unit 225 in communication with the engine 215. The vehicle 205 may further have a steering unit 230 in communication with the transmission unit 225 and a brake unit in communication with the chassis 220. The brake unit may include an emergency brake unit shown as AI emergency brake system 3.

The vehicle 205 may further include one or more batteries (which may include one or more of a metal battery, a solid state metal battery, and a solar battery), a wind turbine, and a fuel cell stack (such as a hydrogen fuel cell unit), which are schematically shown as AI hydrogen fuel cell/solid state metal/water pump system 1 and AI internal fuel cell, AI power control unit and hybrid hydrogen, wind turbine, and solar motor control unit 2. The vehicle 205 may further include a hydrogen storage tank 240 for storing hydrogen acting as a fuel for the vehicle 205. The vehicle 205 may further include an AI battery management unit 16 for controlling the batteries. The vehicle 205 may further include an AI vehicle control unit 235 for controlling the at least one of the engine, the one or more batteries, the wind turbine, and the fuel cell stack. The AI control unit 235 may be further configured to control one or more of a seat, a door, a window, an air conditioner, and an audio unit associated with the vehicle 205. The vehicle 205 may further have an AI one touch seat, door, air conditioner, music, and multi-seat styles control system 5 in communication with the AI control unit 235 for controlling seats, doors, the air conditioner, music, and position styles of the seats of the vehicle 205. The vehicle 205 may further have an AI window lift 5 for controlling windows of the vehicle 205. The vehicle 205 may further have a remote key door and window open-close system shown as an AI one touch/remote key door, and window open-close system 5A in communication with the AI control unit 235 for controlling doors and windows of the vehicle 205.

In an example embodiment, the AI drone control unit 120 shown in FIG. 1 may include a first processor and the AI control unit 235 of the vehicle 205 shown in FIG. 10 may include a second processor. The drone 105 and the vehicle 205 and may further have memories for storing instructions executable by the first processor and the second processor, respectively.

The AI drone control unit 120 shown in FIG. 1 and the AI control unit 235 of the vehicle 205 shown in FIG. 10 may use a machine leaning model to process information associated with operation of the vehicle 205 and the drone 105 using a neural network. The neural network may include a convolutional neural network, an artificial neural network, a Bayesian neural network, a supervised machine learning neural network, a semi-supervised machine learning neural network, an unsupervised machine learning neural network, a reinforcement learning neural network, and so forth.

The vehicle 205 may further have a tire pressure monitoring unit shown as an AI tire pressure monitoring system 6 and an air suspension unit shown as AI air suspension unit 7. The vehicle 205 may further have an AI secure gateway 8 for communication with a remote system such as a remote device, a server, a cloud, a data network, and so forth.

The data network to which the vehicle 205 may be connected may include the Internet or any other network capable of communicating data between devices. Suitable networks may include or interface with any one or more of, for instance, a local intranet, a corporate data network, a data center network, a home data network, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, a Wi-Fi® network, a Bluetooth® network, Bluetooth® radio, or an IEEE 802.11-based radio frequency network. The data network 140 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking.

The vehicle 205 may further have an AI one-touch or one-scan multi-face recognition interface 7A configured to recognize faces, fingerprints, and/or other identity information of users of the vehicle 205 and drone 105.

The vehicle 205 may further have an AI automatic falcon doors 8A (also referred to as falcon-wing doors, gull-wing doors, or up-doors), which are hinged to a top of the vehicle body 210. The AI automatic falcon doors 8A can be used as emergency exits. The vehicle 205 may further have an AI interior lighting system 10 and an exterior lighting system 245.

The vehicle 205 may further have a Heating, Ventilation and Air Conditioning (HVAC) equipment and a HVAC control panel and blower 12 for controlling the HVAC equipment of the vehicle 205.

The vehicle 205 may further include a head-up display shown as an AI cluster and heads-up display 14. The head-up display may display information to a user of the vehicle 205.

The vehicle 205 may further include a plurality of sensors. The plurality of sensors may include one or more of the following: a radar, a laser radar, a lidar, a video camera, a front view camera, a rear view camera, a side camera, an infra-red (IR) camera, a proximity sensor, and so forth. Example sensors are shown as an AI smart rear camera remote parking/self-parking sensor 9, an AI front view camera and laser radar system 11, an AI blind spot detection sensor 13, an AI front radar 17 for adaptive cruise control, and an AI obstacles avoiding cameras and sensors 17A.

The vehicle 205 may further include an engine cooling fan shown as an AI motor cooling fan 18. In some embodiment, the vehicle 205 may further include an AI infotainment unit 15 for displaying information and touch control buttons to the user of the vehicle 205.

The vehicle 205 may further include one or more obstacle detection modules in communication with the plurality of sensors. The obstacle detection modules are shown as AI obstacles avoiding cameras and sensors 17A and may be configured to detect an obstacle in proximity to the vehicle 205 and, upon detection of the obstacle, activate the emergency brake unit.

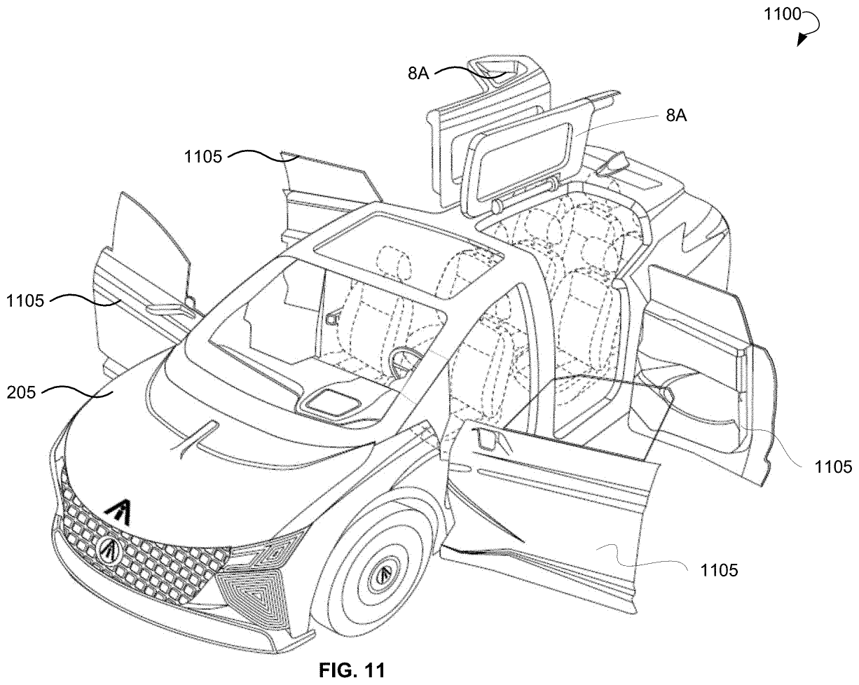

FIG. 11 shows a front perspective view 1100 of the vehicle 205 with all doors 1105 and AI automatic falcon doors 8A open.

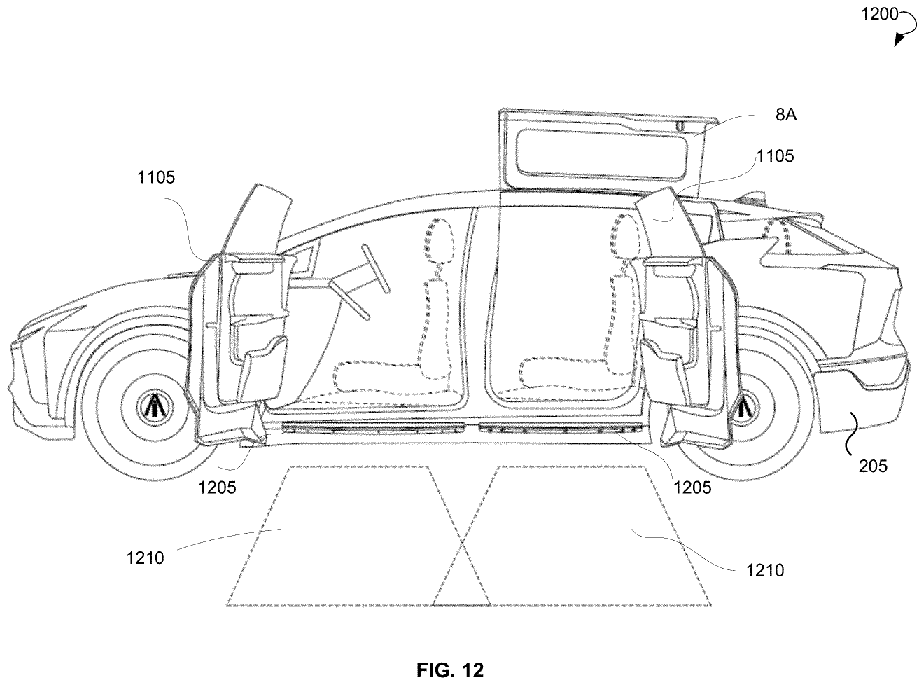

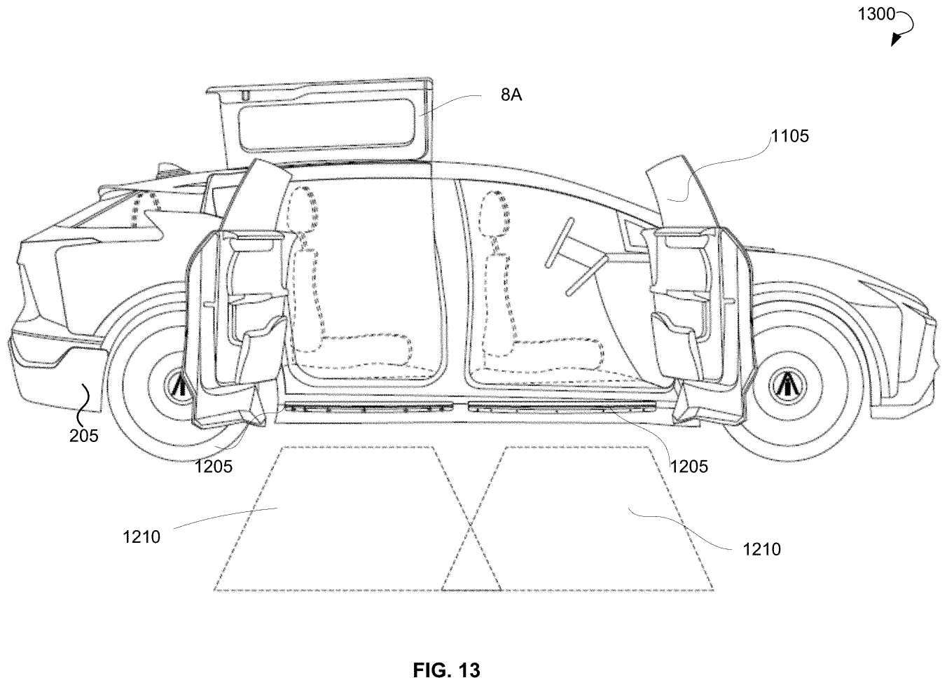

FIG. 12 shows a right side view 1200 of the vehicle 205 and FIG. 13 shows a left side view 1300 of the vehicle 205 with all doors 1105 and AI automatic falcon doors 8A open. The vehicle 205 may further include one or more projectors 1205 in a bottom side portion of vehicle 205 for projecting two virtual red carpets 1210 to welcome users of the vehicle 205 or VIP persons automatically when a key of an owner of the vehicle 205 moves towards the seven seaters super SUV tigon automobile for the AI interaction with VIP persons.

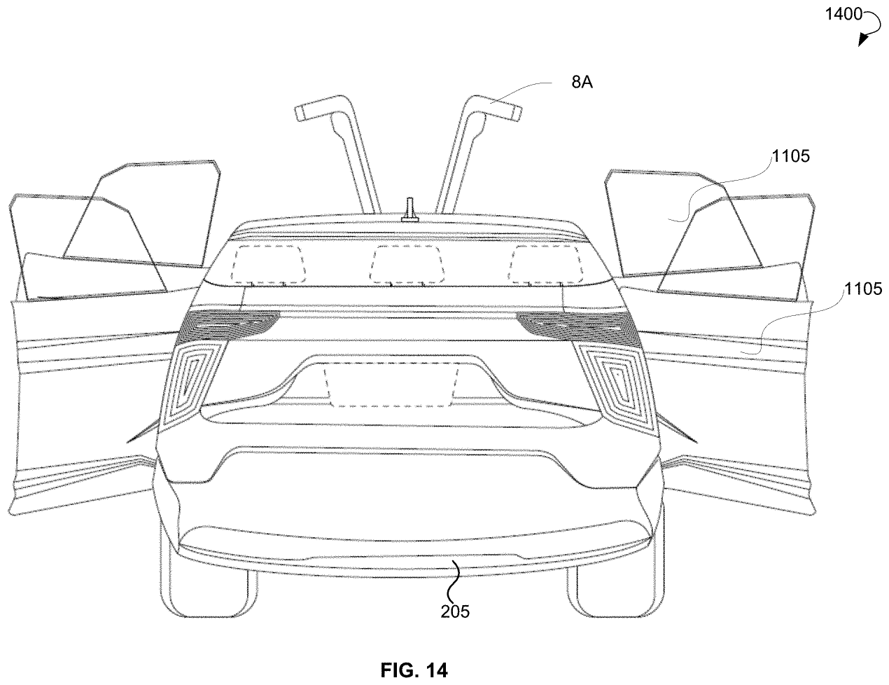

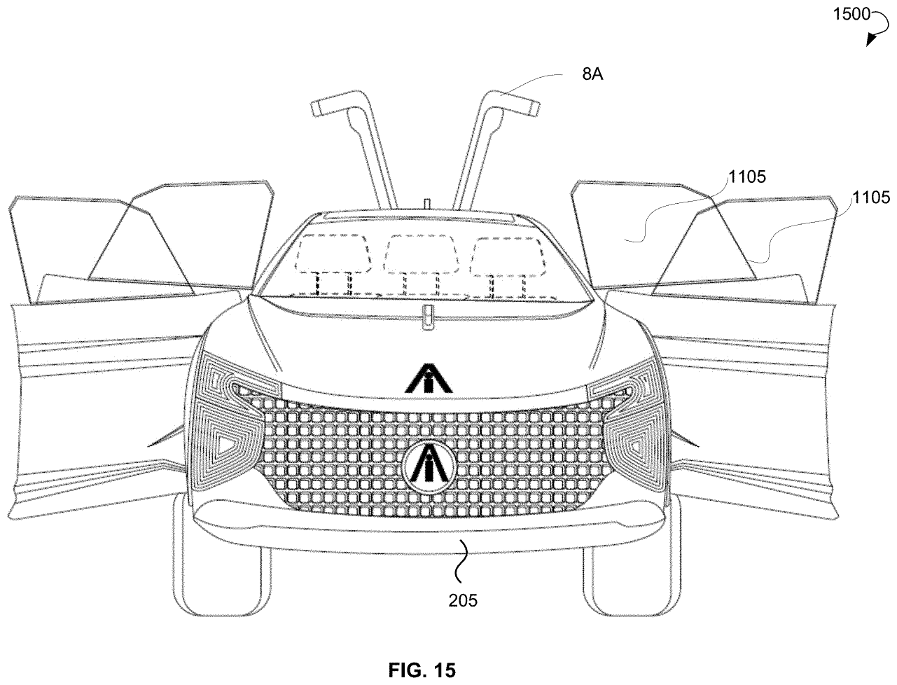

FIG. 14 shows a rear view 1400 of the vehicle 205 and FIG. 15 shows a front view 1500 of the vehicle 205 with all doors 1105 and AI automatic falcon doors 8A open.

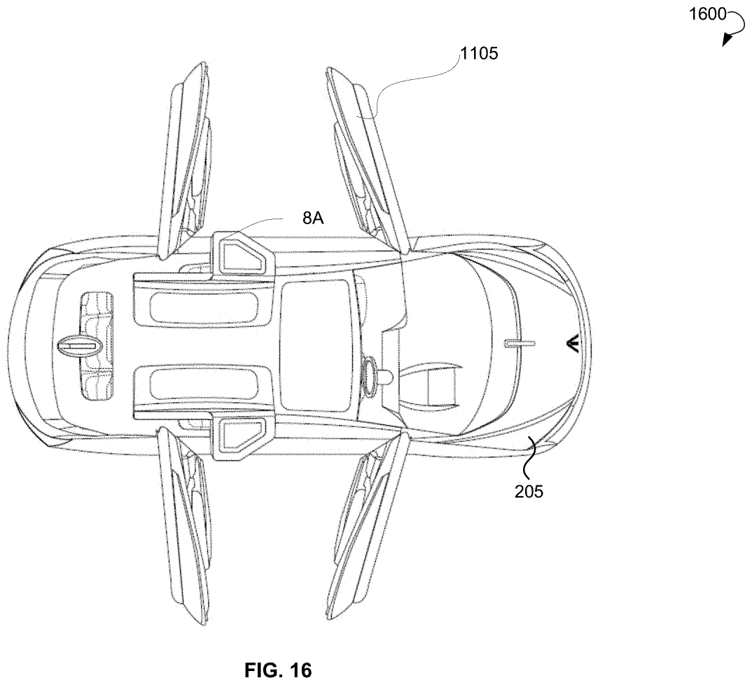

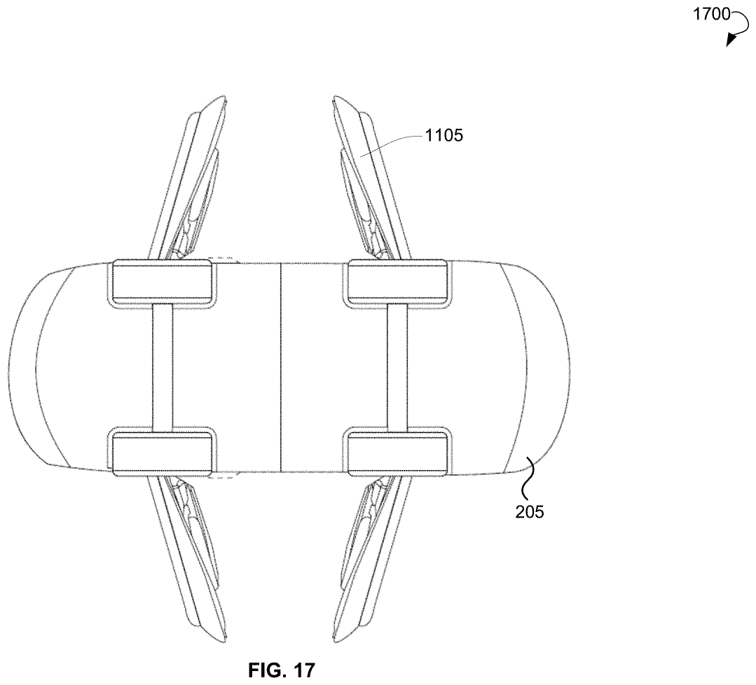

FIG. 16 shows a top view 1600 of the vehicle 205 and FIG. 17 shows a bottom view 1700 of the vehicle 205 with all doors 1105 and AI automatic falcon doors 8A open.

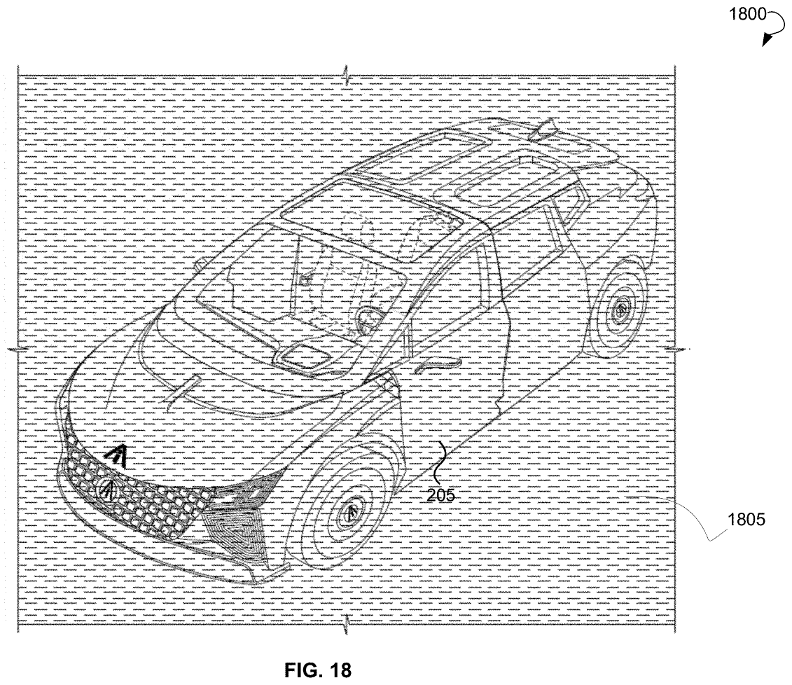

FIG. 18 shows a general perspective view 1800 of the vehicle 205 in a waterproof amphibious alternate configuration. The vehicle 205 is shown submerged under water 1805. The vehicle body of the vehicle 205 and the drone body of the drone may be waterproof. The drone may be configured in submerge under water with the vehicle 205 connected to the drone. The drone may disconnect from the vehicle 205 when being submerged. The vehicle 205 may be configured to drive under water.

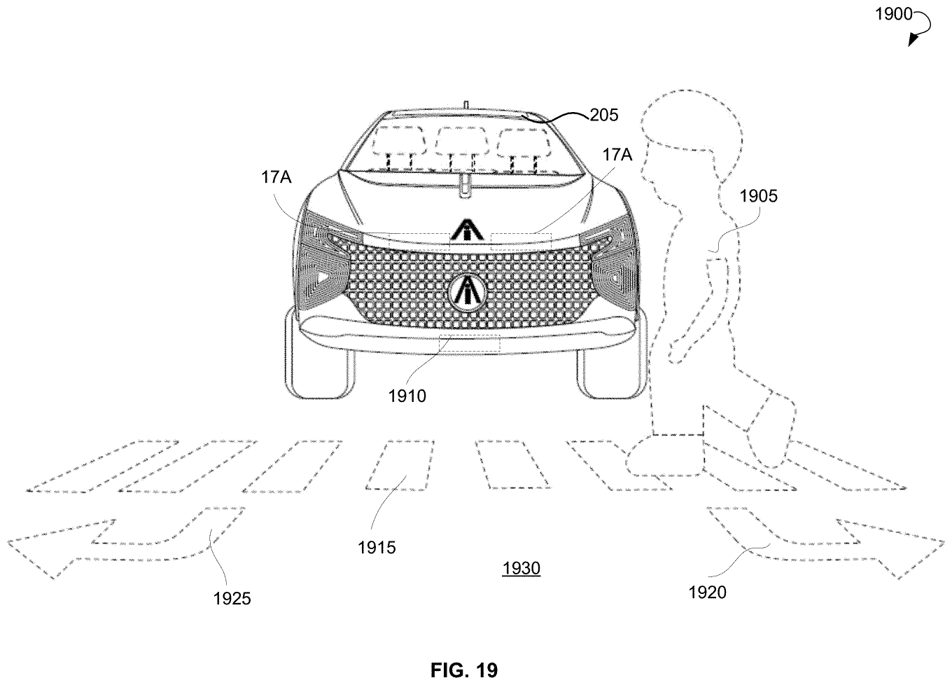

FIG. 19 shows an operation of an obstacle detection module shown as AI obstacles avoiding cameras and sensors 17A and configured to detect an obstacle in proximity to the vehicle 205 and activate the emergency brake unit.

The obstacle detection module may be further configured to detect a crosswalk. No person may be detected on the crosswalk. Based on the detection of the crosswalk, the obstacle detection module may trigger slowing the vehicle 205 down to a predetermined speed. In a further embodiment, the obstacle detection module may be further configured to determine that a person 1905 is entering a crosswalk and based on the determining, trigger stopping the vehicle 205 before the crosswalk. In a further example embodiment, the obstacle detection module may be further configured to determine that the person 1905 is leaving the crosswalk and based on the determining, trigger starting movement of the vehicle 205.

In a further example embodiment, the obstacle detection module may be further configured to detect a crosswalk, determine that a person 1905 is leaving the crosswalk, and based on the determining, continue moving the vehicle 205 at predetermined speed over the crosswalk.

In a further example embodiment, the vehicle 205 may further include a projector 1910. The obstacle detection module may be configured to detect an obstacle, such as a pedestrian shown as a person 1905, and activate the emergency brake unit. The projector 1910 may be configured to project virtual zebra lines 1915, right turning virtual arrows 1920, and left turning virtual arrows 1925 to a roadway 1930 in proximity to the pedestrian upon detection of the pedestrian to show the pedestrian the way and a direction for walking.

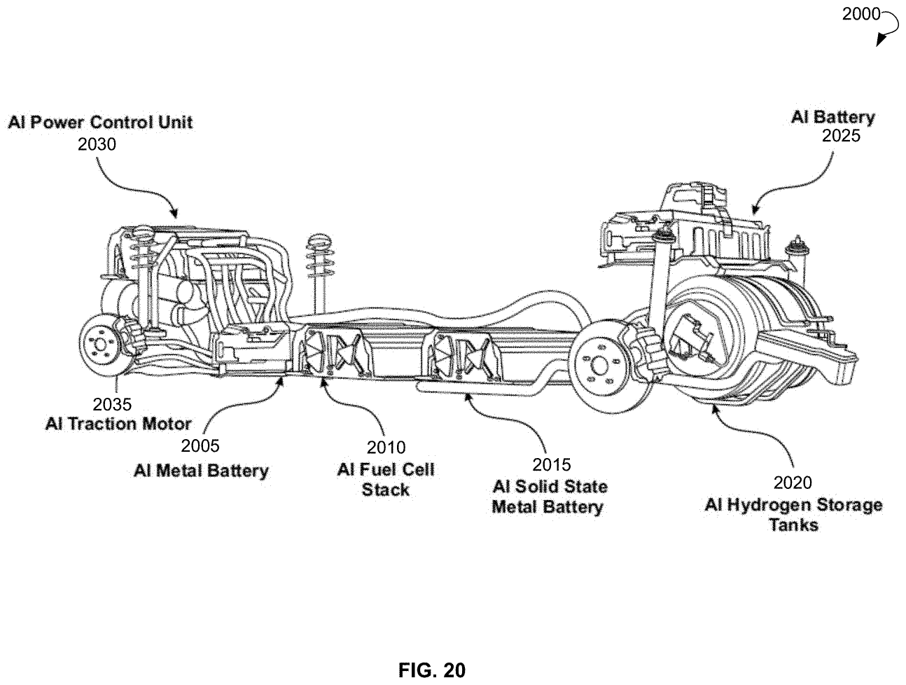

FIG. 20 is a schematic diagram 2000 showing power sources of the vehicle 205. In an example embodiment, the vehicle 205 may include an AI metal battery 2005, an AI fuel cell stack 2010, an AI solid state metal battery 2015, an AI hydrogen storage tanks 2020, an AI battery 2025, an AI power control unit 2030, and an AI traction motor 235. In an example embodiment, the vehicle 205 may be powered by hydrogen, solar, and wind turbine energy. The AI metal battery 2005 may include a lithium-metal battery. The AI solid state metal battery 2015 may have solid electrodes and a solid electrolyte. The AI fuel cell stack 2010 may generate electricity in the form of direct current from electro-chemical reactions that take place in fuel cells of the AI fuel cell stack 2010. The fuel cells may be configured to generate energy by converting the fuel. In an example embodiment, hydrogen may serve as the fuel for the fuel cells of the AI fuel cell stack 2010. The hydrogen may be stored in the AI hydrogen storage tanks 2020. The AI power control unit 2030 may be a part of an AI control unit 235 of the vehicle 205 shown in FIG. 10. The AI power control unit 2030 may be used for controlling the AI metal battery 2005, the AI fuel cell stack 2010, the AI solid state metal battery 2015, the AI hydrogen storage tanks 2020, and the AI battery 2025. The AI traction motor 235 may be powered by a combination of the AI metal battery 2005, the AI fuel cell stack 2010, and the AI solid state metal battery 2015.

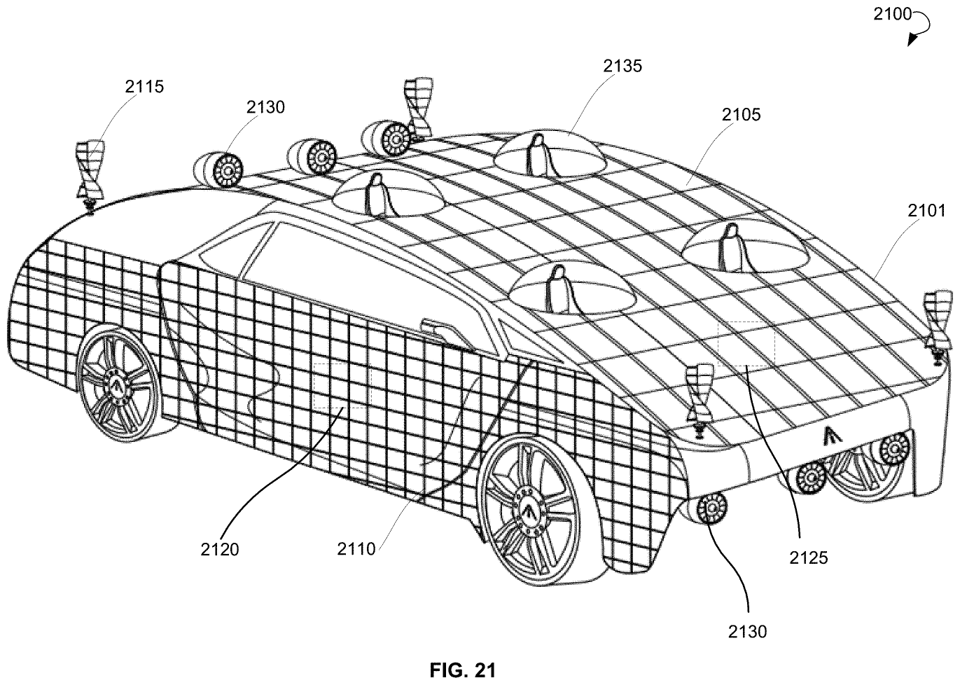

FIG. 21 shows a front perspective view 2100 of an artificial intelligence amphibious vertical take-off and landing modular hybrid flying automobile 2101, according to an example embodiment. The automobile 2101 may include one or more solar panels 2105, 2110, one or more wind turbines 2115, one or more hydrogen tanks 2120, and a stand-alone self-charging self-powered on-board clean energy unit 2125 for controlling the one or more solar panels 2105, 2110, the one or more wind turbines 2115, and one or more hydrogen tanks 2120. The automobile may produce no pollution emissions when operating.

The stand-alone self-charging self-powered on-board clean energy unit 2125 acts an off-the-grid electricity system to using the automobile 2101 in locations that are not equipped with an electricity distribution networks. The stand-alone self-charging self-powered on-board clean energy unit 2125 use one or more methods of electricity generation, hydrogen energy storage, and regulation. The electricity generation is performed by a solar photovoltaic unit using solar panels, a wind turbine, and a hydrogen tank. The stand-alone self-charging self-powered on-board clean energy unit 2125 may be independent of the utility grid and may use solar panels only or in conjunction with a wind turbine or batteries.

The storage of the electricity may be implemented as a battery bank other solutions including fuel cells. The power flowing from the battery may be a direct current extra-low voltage, which may be used for lighting and direct current appliances of the automobile 2101. The stand-alone self-charging self-powered on-board clean energy unit 2125 may use an inverter is generate alternating current low voltage for being used with alternating current appliances of the automobile 2101.

The automobile 2100 may further include one or more propellers 2130 to provide vertical take-off and landing of the automobile 2101. The automobile 2100 may further include a plurality of spheroid seat areas 2135 for accommodating a driver and passengers in the automobile 2101. The spheroid seat areas 2135 may be free of solar batteries.

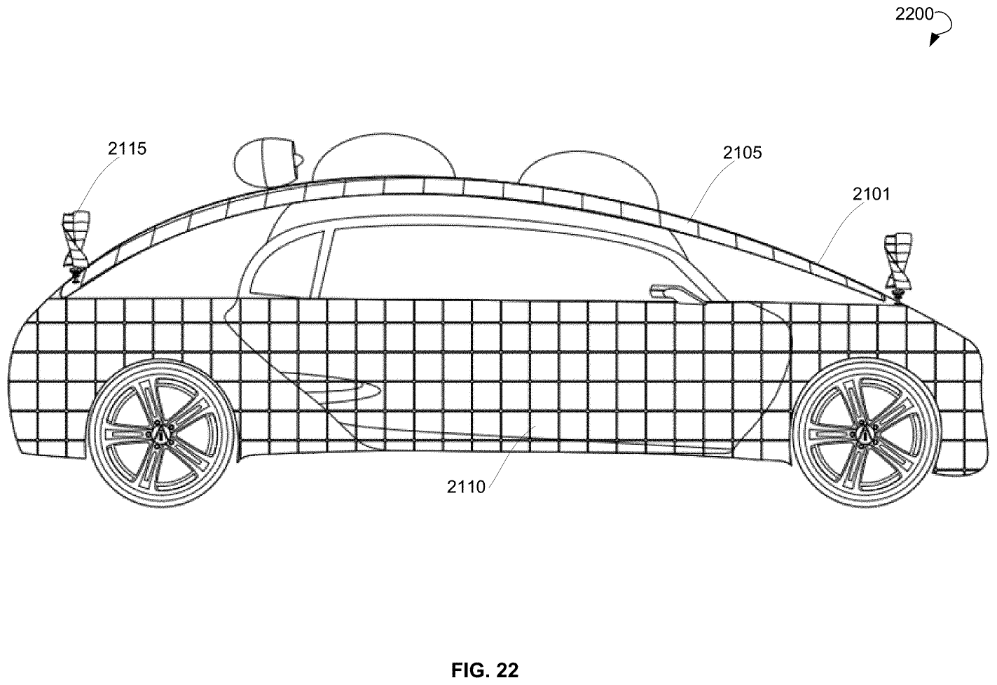

FIG. 22 is a left side view 2200 of an artificial intelligence amphibious vertical take-off and landing modular hybrid flying automobile 2101, according to an example embodiment.

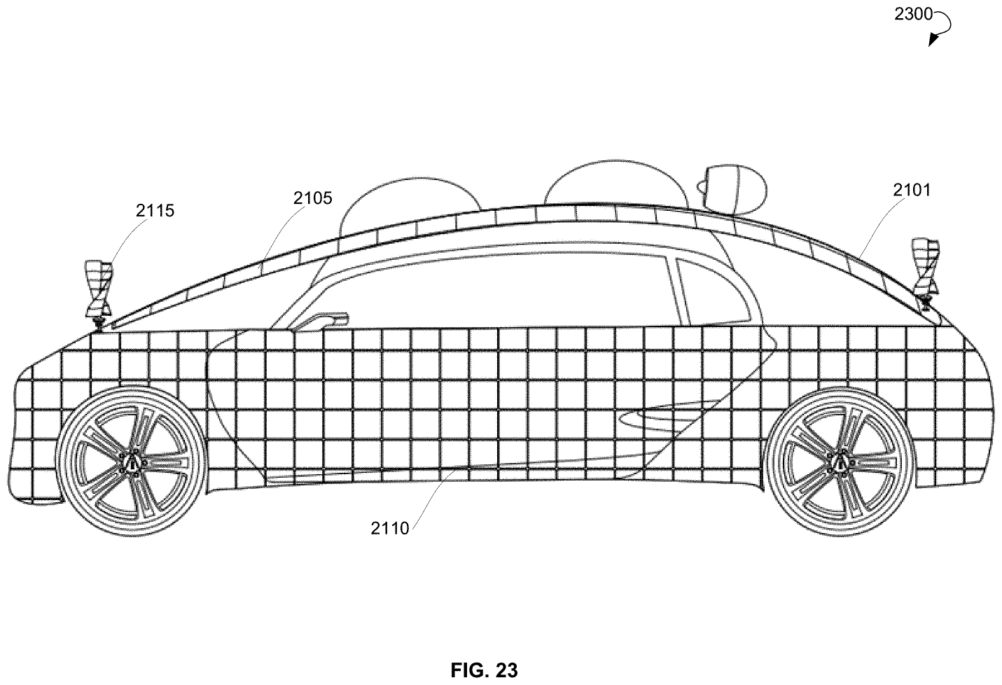

FIG. 23 is a right side view 2300 of an artificial intelligence amphibious vertical take-off and landing modular hybrid flying automobile 2101, according to an example embodiment.

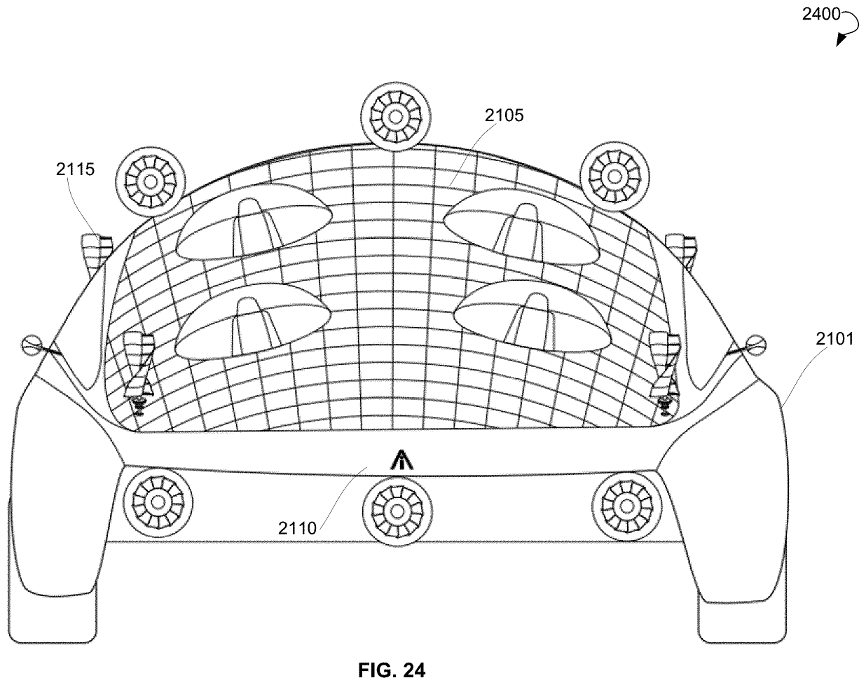

FIG. 24 is a front view 2400 of an artificial intelligence amphibious vertical take-off and landing modular hybrid flying automobile 2101, according to an example embodiment.

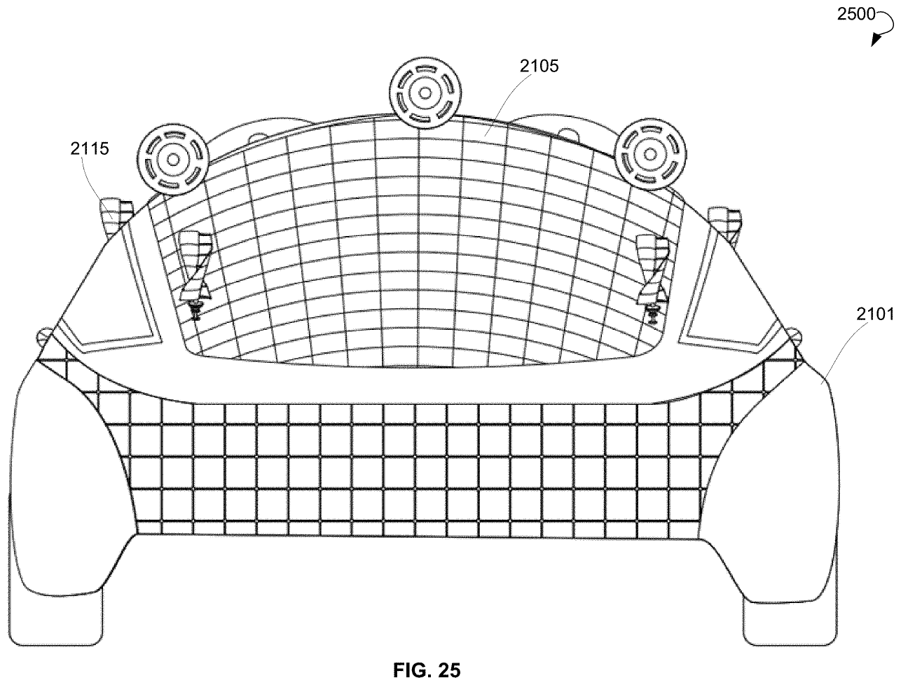

FIG. 25 is a rear view 2500 of an artificial intelligence amphibious vertical take-off and landing modular hybrid flying automobile 2101, according to an example embodiment.

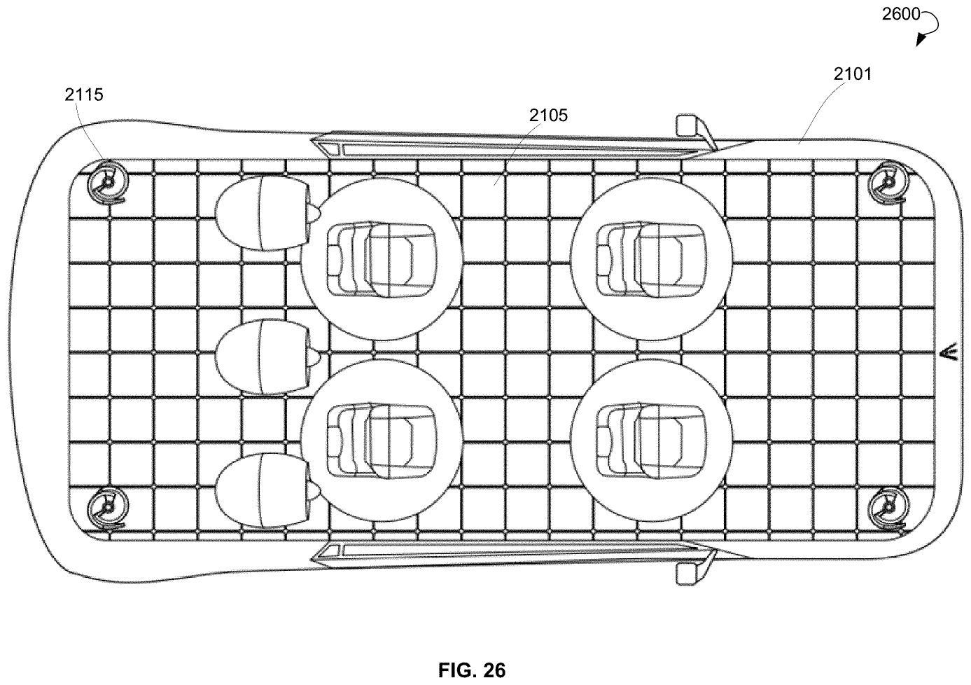

FIG. 26 is a top view 2600 of an artificial intelligence amphibious vertical take-off and landing modular hybrid flying automobile 2101, according to an example embodiment.

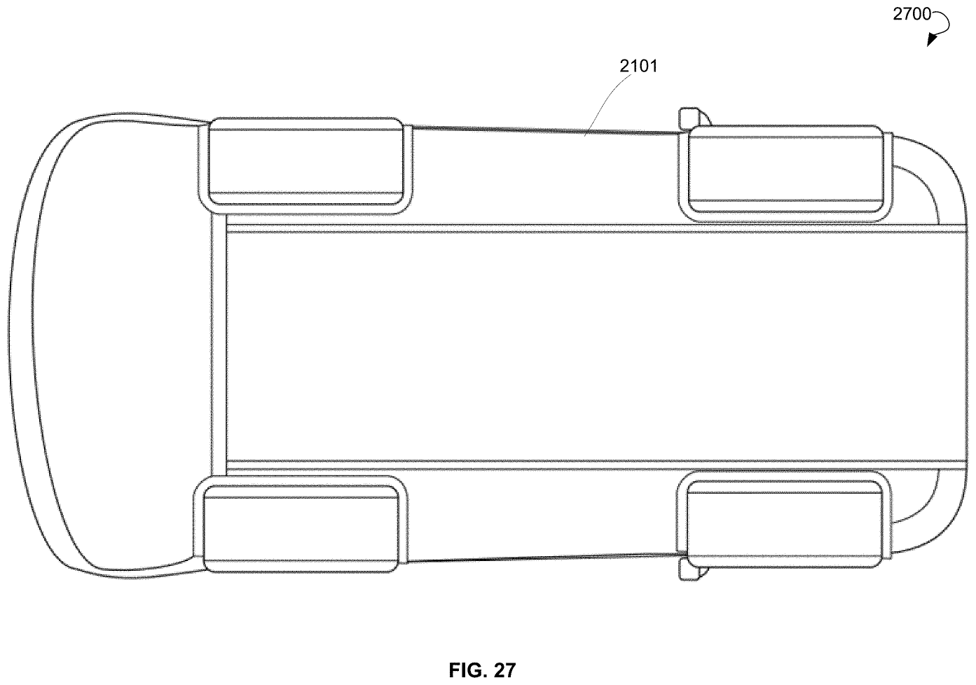

FIG. 27 is a bottom view 2700 of an artificial intelligence amphibious vertical take-off and landing modular hybrid flying automobile 2101, according to an example embodiment.

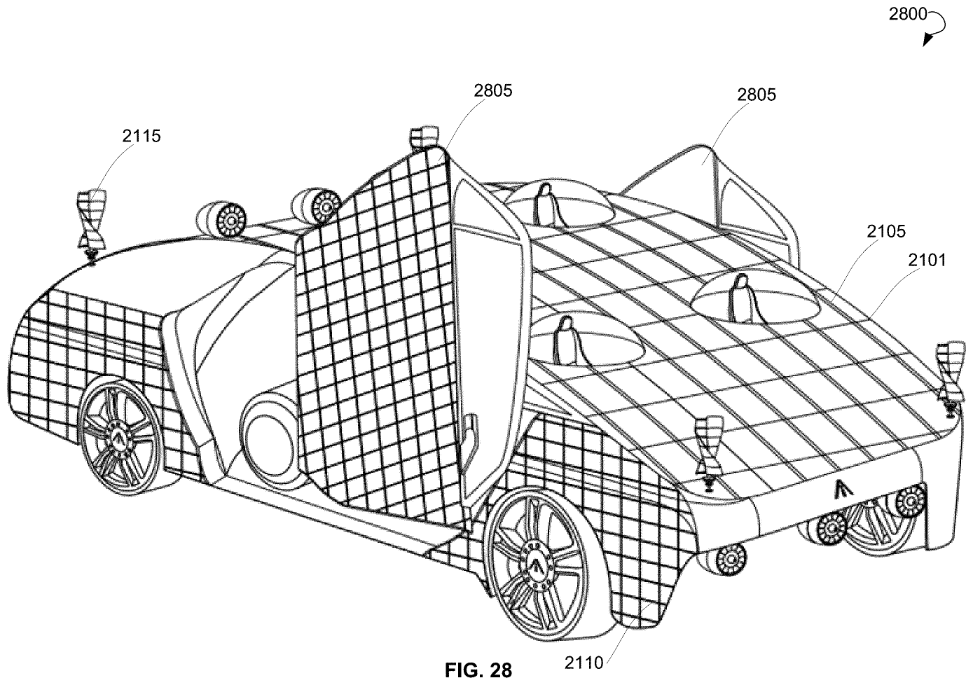

FIG. 28 shows a front perspective view 2800 of an artificial intelligence amphibious vertical take-off and landing modular hybrid flying automobile 2101 with AI automatic falcon doors 2805 open, according to an example embodiment.

The one or more wind turbines may include one or more of the following: a vertical axis wind turbine and a horizontal axis wind turbine. The automobile may further include a fuel cell powertrain, an electric motor, an electric traction motor, a main rechargeable battery, an artificial intelligence drive (AIDRIVE) unit, a touchscreen computer control unit, and a combined artificial intelligence power control unit.

In an example embodiment, the one or more solar panels, the one or more wind turbines, and the one or more hydrogen tanks are combined into a hybrid power plant. The hybrid power plant may be an electrical power supply system configured to meet a range of predetermined power needs. The hybrid power plant may include one or more power sources, one or more batteries, and a power management center. The one or more power sources may include the one or more solar panels, the one or more wind turbines, and the one or more hydrogen tanks, fuel cell stack generators, thermoelectric generators, and a solar photovoltaic unit. The one or more batteries may be configured to provide an autonomous operation of the automobile by compensating for a difference between a power production and a power consumption by the automobile. The power management center may be configured to regulate the power production from each of the one or more power sources, control the power consumption by classifying loads, and protect the one or more batteries from adverse operation states.

In an example embodiment, the solar photovoltaic unit may further include a monitoring photovoltaic unit configured to collect and provide information on an operation of the solar photovoltaic unit, provide recommended actions to improve the operation of the solar photovoltaic unit, and generate a monitoring report including the information on the operation of the solar photovoltaic unit and the recommended actions. The operation of the solar photovoltaic unit may be adjusted based on the monitoring report by selecting a performance parameter and updating a value of the performance parameter. The monitoring photovoltaic unit may be configured to monitor the performance of the solar photovoltaic unit, issue an alert when a loss of the performance is detected, and trigger a preventative action. The monitoring photovoltaic unit may be configured to monitor a state of the one or more batteries and generate a signal when a replacement of the one or more batteries is due before a downtime failure of the one or more batteries is experienced.

In an example embodiment, the AIDRIVE unit may include five levels of control. First and second level may provide a user with an ability to operate the automobile. A third level of the control may provide an environmental detection and makes informed decisions. The informed decisions may include at least accelerating past a slow-moving vehicle. A fourth level of the control may provide a self-driving mode of the automobile. The self-driving mode may be activated within a predetermined geofence. The self-driving mode may include limiting a speed of the automobile to a predetermined speed. A fifth level of the control may provide operating the automobile without requiring an attention of a user. The fifth level of the control may be free from the predetermined geofence and do not require the user to use a steering wheel or acceleration/braking pedals associated with the automobile.

In an example embodiment, the AIDRIVE unit may be configured to perform an analysis of data associated with the automobile based on an analytical model. The AIDRIVE unit may be configured to learn from the data, identify patterns, and make decisions with minimal human intervention.

In an example embodiment, the AIDRIVE unit may be configured to perform on-board computer vision tasks including acquiring, processing, analyzing, and understanding digital images, and extraction of high-dimensional data from real world data to produce numerical or symbolic information to make the decisions. The understanding may include transformation of the digital images into descriptions of the real world data. The understanding may further include disentangling of the numerical or symbolic information from the digital images using geometry models, physics models, statistics models, and learning theory models.

In an example embodiment, the AIDRIVE unit may be configured to apply an on-board computer vision to extract the high-dimensional data from the digital images, the digital images including video sequences, views from multiple cameras, multi-dimensional data from a 3D scanner.

In an example embodiment, the AIDRIVE unit may be configured to use a deep-learning architecture that may include one or more following networks: deep neural networks, deep belief networks, graph neural networks, recurrent neural networks, and convolutional neural networks. The networks may be applied is combination with a computer vision, a machine vision, a speech recognition, a natural language processing, an audio recognition, a social network filtering, a machine translation, bioinformatics, a driver drug design, a medical image analysis, a material inspection, board game programs, the networks producing results corresponding to human expert performance. The AIDRIVE unit may be configured to apply networks for information processing and distributed communication nodes in biological systems. The networks are static and symbolic as compared to a biological brain of living organisms that is dynamic and analogue.

In an example embodiment, the AIDRIVE unit may be configured to apply an aerial reconnaissance that may including reconnaissance for a military or strategic purpose conducted using reconnaissance of aircrafts and automobiles. The aerial reconnaissance my fulfil a plurality of requirements including artillery spotting, collection of imagery intelligence, and observation of animals and pedestrians maneuvers. The AIDRIVE unit may provide a robust intelligence collection management and is complemented by a plurality of non-imaging electro-optical and radar sensors.

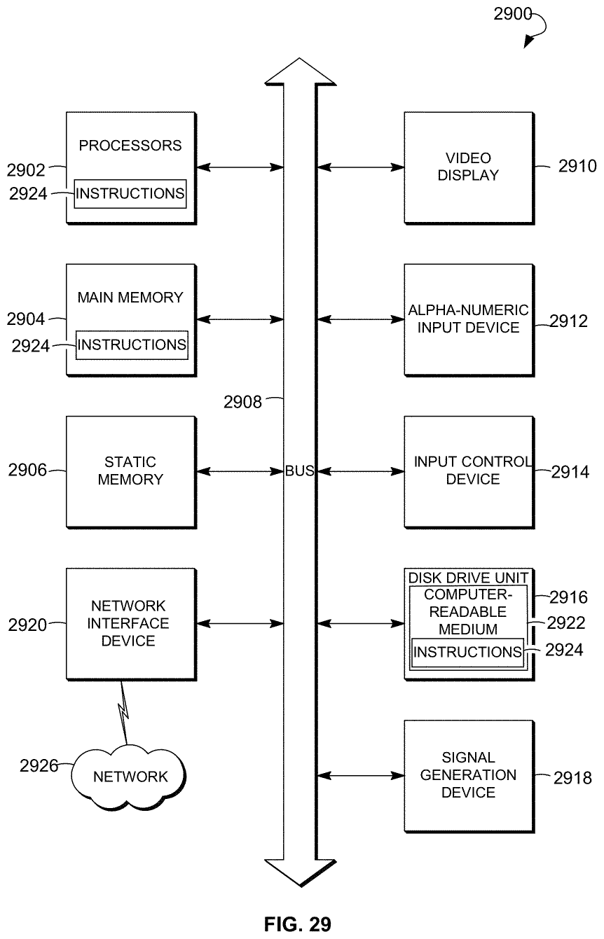

FIG. 29 shows a diagrammatic representation of a machine in the example electronic form of a computer system 2900, within which a set of instructions for causing the machine to perform any one or more of the methodologies discussed herein may be executed. In an example embodiment, the computer system 2900 may act as or be in communication with an AI drone control unit 120 of a drone shown in FIG. 1 and/or an AI control unit 235 of a vehicle 205 shown in FIG. 10. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2900 includes a processor or multiple processors 2902 (e.g., a central processing unit, a graphics processing unit, or both), a main memory 2904 and a static memory 2906, which communicate with each other via a bus 2908. The computer system 2900 may further include a video display unit 2910 (e.g., a liquid crystal display or a light-emitting diode display). The computer system 2900 may also include an alphanumeric input device 2912 (e.g., a keyboard), an input control device 2914 (e.g., a touchscreen), a disk drive unit 2916, a signal generation device 2918 (e.g., a speaker) and a network interface device 2920.

The disk drive unit 2916 includes a non-transitory computer-readable medium 2922, on which is stored one or more sets of instructions and data structures (e.g., instructions 2924) embodying or utilized by any one or more of the methodologies or functions described herein. The instructions 2924 may also reside, completely or at least partially, within the main memory 2904 and/or within the processors 2902 during execution thereof by the computer system 2900. The main memory 2904 and the processors 2902 may also constitute machine-readable media.

The instructions 2924 may further be transmitted or received over a network 2926 via the network interface device 2920 utilizing any one of a number of well-known transfer protocols (e.g., Hyper Text Transfer Protocol).

While the non-transitory computer-readable medium 2922 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory, read only memory, and the like.

Thus, various artificial intelligence amphibious vertical take-off and landing modular hybrid flying automobiles have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. An artificial intelligence amphibious vertical take-off and landing modular hybrid flying automobile comprising:
a vehicle, the vehicle comprising:
a vehicle body;
a chassis carrying the vehicle body;
an engine located in the vehicle body;
a transmission unit in communication with the engine;
a steering unit in communication with the transmission unit;
a brake unit in communication with the chassis, the brake unit including an emergency brake unit;
an artificial intelligence (AI) vehicle control unit;
one or more batteries, the one or more batteries including one or more of a metal battery, a solid state metal battery, and a solar battery;
a wind turbine;
a fuel cell stack, the fuel cell stack including a hydrogen fuel cell unit;
a hydrogen storage tank;
an AI control unit for controlling the at least one of the engine, the one or more batteries, the wind turbine, and the fuel cell stack;
a plurality of sensors; and
an obstacle detection module in communication with the plurality of sensors, the obstacle detection module being configured to detect an obstacle and activate the emergency brake unit; and
a drone, the drone comprising:
a connection unit configured to releasably attach to a top of the vehicle body of the vehicle;
a drone body;
one or more propellers attached to the drone body and configured to provide a vertical take-off and landing of the drone; and
an AI drone control unit.

2. The automobile of claim 1, wherein the obstacle detection module is further configured to:
detect a crosswalk; and
based on the detection, slow the automobile down to a predetermined speed.

3. The automobile of claim 1, wherein the obstacle detection module is further configured to:
determine that a person is entering a crosswalk; and
based on the determining, stop the automobile before the crosswalk.

4. The automobile of claim 3, wherein the obstacle detection module is further configured to:
determine that the person is leaving the crosswalk; and
based on the determining, start moving the automobile.

5. The automobile of claim 1, wherein the obstacle detection module is further configured to:
detect a crosswalk;
determine that a person is leaving the crosswalk; and
based on the determining, continue moving the automobile at predetermined speed over the crosswalk.

6. The automobile of claim 1, wherein the plurality of sensors include one or more of the following: a radar, a laser radar, a LIDAR, a video camera, a front view camera, a rear view camera, a side camera, an infra-red (IR) camera, and a proximity sensor.

7. The automobile of claim 1, wherein the vehicle further comprises an engine cooling fan.

8. The automobile of claim 1, wherein the AI control unit is further configured to control one or more of a seat, a door, a window, an air conditioner, and an audio unit associated with the vehicle.

9. The automobile of claim 1, wherein the vehicle further comprises a remote key door and window open-close system.

10. The automobile of claim 1, wherein the vehicle further comprises a tire pressure monitoring unit.

11. The automobile of claim 1, wherein the vehicle further comprises an air suspension unit.

12. The automobile of claim 1, wherein the vehicle further comprises a secure gateway for communication with a remote system.

13. The automobile of claim 1, wherein the vehicle further comprises a one-touch or one-scan multi-face recognition interface.

14. The automobile of claim 1, wherein the vehicle further comprises an AI automatic falcon door, the AI automatic falcon door including an emergency exit.

15. The automobile of claim 1, wherein the vehicle further comprises an interior lighting system and an exterior lighting system.

16. The automobile of claim 1, wherein the vehicle further comprises a Heating, Ventilation and Air Conditioning equipment and a Heating, Ventilation and Air Conditioning (HVAC) control panel for controlling the Heating, Ventilation and Air Conditioning equipment.

17. The automobile of claim 1, wherein the vehicle further comprises a head-up display.

18. The automobile of claim 1, wherein the vehicle body and the drone body are waterproof, wherein the drone in configured to submerge under water with the vehicle connected to the drone.

19. The automobile of claim 1, wherein the drone further comprises one or more wings, the one or more wings being foldable.

20. An artificial intelligence amphibious vertical take-off and landing modular hybrid flying automobile comprising:
a vehicle, the vehicle comprising:
a vehicle body;
a chassis carrying the vehicle body;
an engine located in the vehicle body;
a transmission unit in communication with the engine;
a steering unit in communication with the transmission unit;
a brake unit in communication with the chassis, the brake unit including an emergency brake unit;
an artificial intelligence (AI) vehicle control unit;
one or more batteries, the one or more batteries including one or more of a metal battery, a solid state metal battery, and a solar battery;
a wind turbine;
a fuel cell stack, the fuel cell stack including a hydrogen fuel cell unit;
a hydrogen storage tank;
an AI control unit for controlling the at least one of the engine, the one or more batteries, the wind turbine, and the fuel cell stack;
a plurality of sensors;
an obstacle detection module in communication with the plurality of sensors, the obstacle detection module being configured to detect an obstacle and activate the emergency brake unit, wherein the obstacle is a pedestrian; and
a projector configured to project virtual zebra lines, right turning virtual arrows, and left turning virtual arrows to a roadway in proximity to the pedestrian upon detection of the pedestrian; and
a drone, the drone comprising:
a connection unit configured to releasably attach to a top of the vehicle body of the vehicle;
a drone body;
one or more propellers attached to the drone body and configured to provide a vertical take-off and landing of the drone; and
an AI drone control unit.

21. An artificial intelligence amphibious vertical take-off and landing modular hybrid flying automobile comprising:
one or more solar panels;
one or more wind turbines;
one or more hydrogen tanks; and
a stand-alone self-charging self-powered on-board clean energy unit for controlling the one or more solar panels, the one or more wind turbines, and one or more hydrogen tanks;
wherein the automobile produces no pollution emissions when operating.

22. The artificial intelligence amphibious vertical take-off and landing modular hybrid flying automobile of claim 21, wherein the one or more wind turbines include one or more of the following: a vertical axis wind turbine and a horizontal axis wind turbine; and
wherein the automobile further includes a fuel cell powertrain, an electric motor, an electric traction motor, a main rechargeable battery, an artificial intelligence drive (AIDRIVE) unit, a touchscreen computer control unit, and a combined artificial intelligence power control unit.

23. The artificial intelligence amphibious vertical take-off and landing modular hybrid flying automobile of claim 21, wherein the one or more solar panels, the one or more wind turbines, and the one or more hydrogen tanks are combined into a hybrid power plant;
wherein the hybrid power plant is an electrical power supply system configured to meet a range of predetermined power needs, wherein the hybrid power plant includes one or more power sources, one or more batteries, and a power management center;
wherein the one or more power sources include the one or more solar panels, the one or more wind turbines, and the one or more hydrogen tanks, fuel cell stack generators, thermoelectric generators, and a solar photovoltaic unit;
wherein the one or more batteries are configured to provide an autonomous operation of the automobile by compensating for a difference between a power production and a power consumption by the automobile; and
wherein the power management center is configured to regulate the power production from each of the one or more power sources, control the power consumption by classifying loads, and protect the one or more batteries from adverse operation states.

24. The artificial intelligence amphibious vertical take-off and landing modular hybrid flying automobile of claim 23, wherein the solar photovoltaic unit further includes a monitoring photovoltaic unit, the monitoring photovoltaic unit is configured to collect and provide information on an operation of the solar photovoltaic unit, provide recommended actions to improve the operation of the solar photovoltaic unit, and generate a monitoring report including the information on the operation of the solar photovoltaic unit and the recommended actions;
wherein the operation of the solar photovoltaic unit is adjusted based on the monitoring report by selecting a performance parameter and updating a value of the performance parameter;
wherein the monitoring photovoltaic unit is configured to monitor the performance of the solar photovoltaic unit, issue an alert when a loss of the performance is detected, and trigger a preventative action; and
wherein the monitoring photovoltaic unit is configured to monitor a state of the one or more batteries and generate a signal when a replacement of the one or more batteries is due before a downtime failure of the one or more batteries is experienced.

25. The artificial intelligence amphibious vertical take-off and landing modular hybrid flying automobile of claim 22, wherein the AIDRIVE unit includes five levels of control, wherein a third level of the control provides an environmental detection and makes informed decisions, the informed decisions including at least accelerating past a slow-moving vehicle;
wherein a fourth level of the control provides a self-driving mode of the automobile, wherein the self-driving mode is activated within a predetermined geofence, wherein the self-driving mode includes limiting a speed of the automobile to a predetermined speed;
wherein a fifth level of the control provides operating the automobile without requiring an attention of a user, the fifth level of the control is free from the predetermined geofence and do not require the user to use a steering wheel or acceleration/braking pedals associated with the automobile.

26. The artificial intelligence amphibious vertical take-off and landing modular hybrid flying automobile of claim 25, wherein the AIDRIVE unit is configured to perform an analysis of data associated with the automobile based on an analytical model, whether the AIDRIVE unit is configured to learn from the data, identify patterns, and make decisions with minimal human intervention.

27. The artificial intelligence amphibious vertical take-off and landing modular hybrid flying automobile of claim 26, wherein the AIDRIVE unit is configured to perform on-board computer vision tasks, the on-board computer vision tasks including acquiring, processing, analyzing, and understanding digital images, and extraction of high-dimensional data from real world data to produce numerical or symbolic information to make the decisions, the understanding includes transformation of the digital images into descriptions of the real world data, wherein the understanding further includes disentangling of the numerical or symbolic information from the digital images using geometry models, physics models, statistics models, and learning theory models.

28. The artificial intelligence amphibious vertical take-off and landing modular hybrid flying automobile of claim 27, wherein the AIDRIVE unit is configured to apply an on-board computer vision to extract the high-dimensional data from the digital images, the digital images including video sequences, views from multiple cameras, multi-dimensional data from a 3D scanner.

29. The artificial intelligence amphibious vertical take-off and landing modular hybrid flying automobile of claim 22, wherein the AIDRIVE unit is configured to use a deep-learning architecture, the deep-learning architecture including one or more following networks: deep neural networks, deep belief networks, graph neural networks, recurrent neural networks, and convolutional neural networks, the networks being applied is combination with a computer vision, a machine vision, a speech recognition, a natural language processing, an audio recognition, a social network filtering, a machine translation, bioinformatics, a driver drug design, a medical image analysis, a material inspection, board game programs, the networks producing results corresponding to human expert performance;
wherein the AIDRIVE unit is configured to apply networks for information processing and distributed communication nodes in biological systems, wherein the networks are static and symbolic.

30. The artificial intelligence amphibious vertical take-off and landing modular hybrid flying automobile of claim 22, wherein the AIDRIVE unit is configured to apply an aerial reconnaissance, the aerial reconnaissance including reconnaissance for a military or strategic purpose conducted using reconnaissance of aircrafts and automobiles, the aerial reconnaissance fulfilling a plurality of requirements including artillery spotting, collection of imagery intelligence, and observation of animals and pedestrians maneuvers; and
wherein the AIDRIVE unit provides a robust intelligence collection management and is complemented by a plurality of non-imaging electro-optical and radar sensors.
